(19) United States
(12) Patent Application Publication
(10) Pub. No.: US 2025/0315211 A1
(43) Pub. Date: Oct. 9, 2025

(54) EXPONENTIAL FUNCTION CALCULATOR FOR CALCULATING EXPONENTIAL FUNCTIONS INVOLVING DECIMALS AND METHOD OF OPERATING THE SAME

(71) Applicant: Electronics and Telecommunications Research Institute, Daejeon (KR)

(72) Inventors: Hyuk KIM, Daejeon (KR); In San JEON, Daejeon (KR); Tae Wook KANG, Daejeon (KR); Sung Eun KIM, Daejeon (KR); Kyung Jin BYUN, Daejeon (KR); Kwang IL OH, Daejeon (KR); Jae-Jin LEE, Daejeon (KR)

(73) Assignee: Electronics and Telecommunications Research Institute, Daejeon (KR)

(21) Appl. No.: 19/098,103

(22) Filed: Apr. 2, 2025

(30) Foreign Application Priority Data
Apr. 4, 2024 (KR) 10-2024-0045821

(51) Int. Cl. G06F 7/556; G06F 5/01; G06F 7/485; G06F 7/487

(52) U.S. Cl. CPC G06F 7/556; G06F 5/01; G06F 7/485; G06F 7/4873; G06F 7/4876

(57) ABSTRACT

Disclosed is an exponential function calculator, which includes a divider configured to divide exponential data into integer data, decimal data, and sign data, a power calculator configured to generate first multiplication data equal to the decimal data and to generate second multiplication data indicating a result of a first order power operation of the decimal data, a coefficient calculator, an adder-subtractor configured to generate addition data indicating a result of an addition operation of the first operation data and the second operation data based on the sign data, and a shifter configured to perform a shift operation of the addition data based on the integer data to generate function data, wherein the coefficient calculator is configured to perform first to N-th right shift operations of the first multiplication data based on first to N-th coefficient data, respectively.

### CROSS-REFERENCE TO RELATED APPLICATIONS

This application claims priority under 35 U.S.C. § 119 to Korean Patent Application No. 10-2024-0045821 filed on Apr. 4, 2024, in the Korean Intellectual Property Office, the disclosure of which is incorporated by reference herein in their entirety.

### BACKGROUND

Embodiments of the present disclosure described herein relate to exponential function calculators and methods of operating the same, and more particularly, relate to exponential function calculators for calculating exponential functions involving decimals and methods of operating the same.

An exponential function is a function having the form of a^{x}. a is referred to as the base of the exponential function, and x is referred to as an exponent of the exponential function. Exponential functions are used in various industries such as artificial intelligence, cryptography, and communications. In particular, exponential functions with a base of 2 or e are importantly used in various industrial fields.

The exponent of the exponential function may be any real number. When the exponent comprises decimals, the operation of the exponential function may be significantly slower than when the exponent is an integer. Thus, quickly performing the operation of an exponential function including decimals is an important industry challenge in an industry where the operation of exponential functions is frequently used.

### SUMMARY

Embodiments of the present disclosure provide an exponential function calculator for calculating an exponential function including decimals and a method of operating the same.

According to an embodiment of the present disclosure, an exponential function calculator is provided. The exponential function calculator includes a divider configured to divide exponential data into integer data, decimal data, and sign data, a power calculator configured to generate first multiplication data equal to the decimal data and to generate second multiplication data indicating a result of a first order power operation of the decimal data, a coefficient calculator configured to generate first operation data based on the first multiplication data and to generate second operation data based on second multiplication data, an adder-subtractor configured to generate addition data indicating a result of an addition operation of the first operation data and the second operation data based on the sign data, and a shifter configured to perform a shift operation of the addition data based on the integer data and to generate function data indicating a result of the shift operation, wherein the coefficient calculator is configured to perform first to N-th right shift operations of the first multiplication data based on first to N-th coefficient data, respectively, and to generate the first operation data corresponding to a sum of results of the first to N-th right shift operations, and N is a natural number.

According to an embodiment of the present disclosure, a method of operating an exponential function calculator is provided. The method operating the exponential function calculator includes dividing exponential data into integer data, decimal data, and sign data, generating first multiplication data equal to the decimal data, generating second multiplication data indicating a result of a first order power operation of the decimal data; performing first to N-th right shift operations of the first multiplication data based on first to N-th coefficient data, respectively, wherein N is a natural number, generating first operation data corresponding to a sum of the results of the first to N-th rights shift operations, generating second operation data based on the second multiplication data, generating addition data indicating a result of an addition operation of the first operation data and the second operation data based on the sign data, and performing a shift operation of the addition data based on the integer data, and generating function data indicating a result of the shift operation.

### BRIEF DESCRIPTION OF DRAWINGS

The above and other objects and features will be more apparent from the following description of embodiments, taken in conjunction with the accompanying drawings, in which:

FIG. 1 is a block diagram illustrating an electronic system according to an embodiment of the present disclosure.

FIG. 2 is a block diagram illustrating an exponential function calculator according to an embodiment of the present disclosure.

FIG. 3 is a diagram illustrating a power calculator according to some embodiments of the present disclosure.

FIG. 4 is a diagram illustrating a coefficient calculator according to some embodiments of the present disclosure.

FIG. 5 is a diagram illustrating an adder-subtractor according to some embodiments of the present disclosure.

FIG. 6 is a block diagram of an exponential function calculator in accordance with some embodiments of the present disclosure.

FIG. 7 is a flowchart illustrating a method of operating an exponential function calculator according to an embodiment of the present disclosure.

### DETAILED DESCRIPTION

Below, embodiments of the present disclosure will be described in detail and clearly to such an extent that an ordinary one in the art easily carries out the present disclosure.

Hereinafter, embodiments of the present disclosure will be described in more detail with reference to the accompanying drawings. In describing the present disclosure, similar reference numerals are used for similar components on the drawings to facilitate overall understanding, and duplicated descriptions of similar components will be omitted.

As used herein, including in the claims, “or” as used in a list of items (e.g., a list of items prefaced by a phased such as “at least one of” or “one or more of” or “one or both of” indicates as inclusive list such that, for example, a list of at least one of A, B, or C means A or B or C or AB or AC or BC or ABC (i.e., A and B and C).

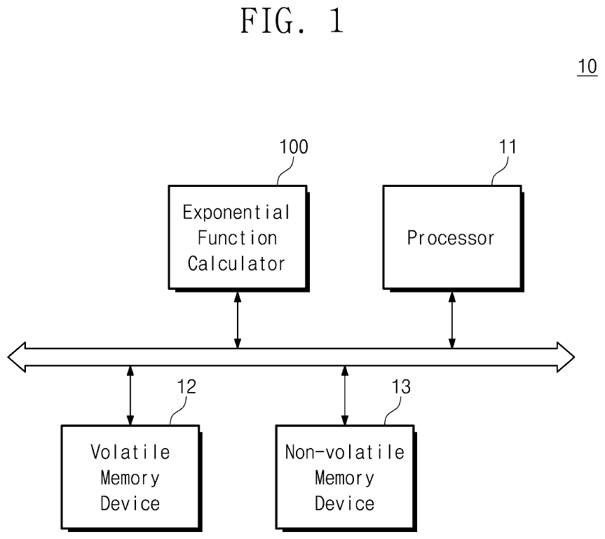

FIG. 1 is a block diagram illustrating an electronic system according to an embodiment of the present disclosure. Referring to FIG. 1, an electronic system 10 may include an exponential function calculator 100, a processor 11, a volatile memory device 12, and a non-volatile memory device 13.

In some embodiments, the electronic system 10 may be implemented as an electronic device having wired and/or wireless communication capabilities or may be implemented as part of the electronic device. For example, the electronic system 10 may be implemented as at least one of a smartphone, a tablet personal computer (PC), a mobile phone, a video phone, an e-book reader, a desktop PC, a laptop PC, a netbook computer, a workstation, a server, a PDA, a portable multimedia player (PMP), an MP3 player, a camera, a wearable device, various medical devices (e.g., various portable medical measuring devices (such as a blood glucose meter, a heart rate meter, a blood pressure meter, or a body temperature meter), a magnetic resonance angiography (MRA), a magnetic resonance imaging (MRI), a computed tomography (CT), an imager, an ultrasonicator, etc.), a navigation device, a global navigation satellite system (GNSS), an event data recorder (EDR), a right data recorder (FDR), an automotive infotainment device, marine electronic equipment (e.g, a marine navigation device, a gyro compass, etc.), avionics, a security device, a head unit for a vehicle, an industrial or household robot, a drone, an ATM of a financial institution, a point of sales (POS) of a store, or an internet of things device (e.g; a light bulb, various sensors, a sprinkler device, a fire alarm, a thermostat, a street light, an exercise device, etc.).

The exponential function calculator 100 may be a separate hardware device that assists in the calculation of the processor 11 or performs a part of the calculations of the processor 11 instead. For example, the exponential function calculator 100 may be a hardware accelerator, a Field Programmable Gate Array (FPGA), or the like. The exponential function computer 100 may receive data from the processor 11, and provide a result of computing the data to the processor 11.

The processor 11 may be implemented as a computing device such as a central processing unit (CPU), a graphics processing unit (GPU), a neural processing unit (NPU), or the like.

The volatile memory device 12 may store data. The volatile memory device 12 may be implemented as a DRAM (Dynamic Random Access Memory), an SRAM (Static RAM), or the like, in which stored data disappears when power supply is interrupted.

The non-volatile memory device 13 may store data. The non-volatile memory device 13 can retain the stored data even when power supply is interrupted. For example, the non-volatile memory device 120 may be implemented as a NAND (not and) based flash memory device, a NOR (not or) based flash memory devices, a Phase-change RAM (PRAM), a Magnetic RAM (MRAM), a Resistive RAM (RRAM), etc.

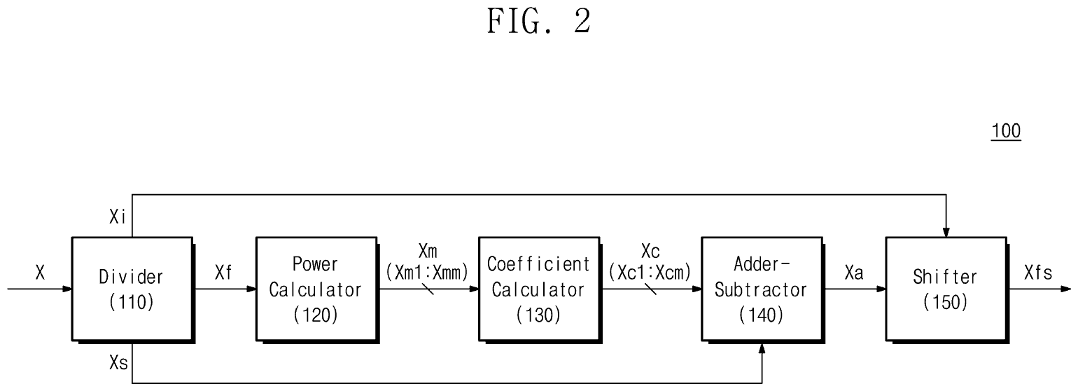

FIG. 2 is a block diagram illustrating an exponential function calculator according to an embodiment of the present disclosure. Referring to FIG. 2, the exponential function calculator 100 may include a divider 110, a power calculator 120, a coefficient calculator 130, an adder-subtractor 140, and a shifter 150, which may be implemented by one or more dedicated hardware components including one or more of logic gates or circuits, registers, memories, interface circuits, etc. configured to perform functions as described herebelow in association with the processor 11. The exponential function calculator 100 may calculate an exponential function. For example, the exponential function calculator 100 may operate an exponential function having the exponential data X as an input. An example exponential function may be expressed as Equation 1.

$$y = {a}^{b} \qquad [ Equation 1 ]$$

y and b are any real numbers, and a is any positive real number. The exponential function calculator 100 may calculate an exponential function with base a (e.g., with base 2) based on exponential data X corresponding to b and generate function data Xfs corresponding to y. A Maclaurin's series may be used to calculate the exponential function. The Maclaurin's series can be expressed as Equation 2.

$$f ( z ) = {\sum }_{m = 0}^{∞} \frac{{f}^{m} ( 0 )}{m !} {( z - 0 )}^{m} \qquad [ Equation 2 ]$$

z is a real number, and m is any natural number (0 or a positive integer). The Maclaurin's series is a form in which the integer part is 0 in the Taylor series. The Maclaurin's series can be expressed as Equation 3.

$$f ( z ) = f ( 0 ) + \frac{{f}^{′} ( 0 )}{1 !} z + \frac{{f}^{″} ( 0 )}{2 !} {z}^{2} + \frac{{f}^{′′′} ( 0 )}{3 !} {z}^{3} + … \qquad [ Equation 3 ]$$

Any function may be represented as a polynomial involving powers of z, as shown in Equation 3, which is the Maclaurin's series.

$${2}^{b} = {2}^{{b}_{i} + {b}_{f}} = {2}^{{b}_{i}} \cdot {2}^{{b}_{f}} \qquad [ Equation 4 ]$$

bᵢ is any integer that is an integer part of b, and b_{f} is any decimal that is a decimal part of b. An exponential function with 2 as a base and b as an exponent can be expressed as Equation 4. Referring to Equation 4, the value of 2^{b} is a value resulting from performing a multiplication operation of a value of 2^{b}f that is a decimal part of 2^{b} and a value of 2^{bi} that is an integer part of 2^{b}.

The multiplication operation of any real number and 2^{bi} may be the same as shifting the bits indicating any real number by bᵢ. Accordingly, the value of 2^{b} may be equal to a value corresponding to a result of shifting bits indicating a result of computing 2^{bf} by bᵢ. For example, when bi is a positive integer, the value of 2^{b} may be equal to a value corresponding to a result of shifting bits indicating a result of computing 2^{bf} to the right, and when bᵢ is a negative integer, the value 2^{e} may be equal to a value corresponding to a result of shifting bits indicating a result of computing 2^{bf} to the left.

$${2}^{bf} = {2}^{0} + {2}^{0} ( ln 2 ) {b}_{f} + \frac{1}{2} {2}^{0} {( ln 2 )}^{2} {( {b}_{f} )}^{2} + … \qquad [ Equation 5 ]$$

Referring to Equation 5, 2^{bf} of Equation 4 may be expressed as a polynomial using the Maclaurin's series of Equation 3. For example, 2^{bf} may be represented by a polynomial involving a plurality of terms consisting of the multiplication of the power of b_{f} and the coefficients (which are real numbers).

$${2}^{bf} \approx 1 + ( 0.69314 ) {b}_{f} + ( 0.24022 ) {( {b}_{f} )}^{2} + ( 0.0555 ) {( {b}_{f} )}^{3} \qquad [ Equation 6 ]$$

Referring to Equation 6, the polynomial of Equation 5 (the Maclaurin's series of 2^{bf}) can be approximated to have four power terms with indices of 0 to 3, respectively. The approximated Maclaurin's series of 2^{bf} can be expressed as a sum of 1 and three terms with different coefficients.

The exponential function calculator 100 may operate an exponential function having exponential data X as an input, and generate function data Xfs corresponding to an approximated result value of the exponential function. For example, the exponential function calculator 100 may calculate an exponential function having, as an input, exponential data X corresponding to b in Equation 6 and generate function data Xfs corresponding to a result corresponding to y.

Unlike the exponential function calculator 100 of the present disclosure, a typical exponential function calculator calculates an exponential function using result values of the exponential function involving decimals pre-stored in a Look-Up Table (LUT). Therefore, a general exponential function calculator searches for a value necessary for computation of an exponential function in the look-up table, and computes the exponential function based on a value approximating the value of the input exponential. That is, a typical exponential function calculator provides users with slow and inaccurate exponential function computation. The exponential function calculator 100 of the present disclosure can quickly and accurately calculate an exponential function by directly calculating coefficients of a polynomial of a Maclaurin's series, instead of referring to a look-up table for calculation of the exponential function.

The exponential function calculator 100 may receive the exponential data X from an external device (e.g., the processor 11, the main memory 12, or the storage device 13 in FIG. 1) and provide the function data Xfs to the external device.

The divider 110 may divide the exponential data X into integer data Xi, decimal data Xf, and sign data Xs. For example, the divider 110 may divide the exponential data X indicating any real number (corresponding to 2^{b} in Equation 4) into integer data Xi (corresponding 2^{bi}), decimal data Xf corresponding to 2^{bf}, and sign data Xs corresponding to the sign of 2^{bi}.

In some embodiments, divider 110 may provide the integer data (Xi) to the shifter 150, the decimal data (Xf) to power calculator 120, and the sign data (Xs) to the adder-subtractor 140.

The power calculator 120 may generate multiplication data Xm. For example, the power calculator 120 may generate the multiplication data Xm based on the decimal data Xf received from the divider 110. In some embodiments, the multiplication data Xm may refer to 2^{bf} (excluding coefficients) and powers of 2^{bf} in Equation 6. The power calculator 120 may provide the multiplication data Xm to the coefficient calculator 130.

In some embodiments, the multiplication data Xm may include first to m-th multiplication data Xm1:Xmm. For example, the multiplication data Xm may include first multiplication data Xm1 indicating 2^{bf}, second multiplication data Xm2 indicating (2^{bf})², and third multiplication data Xm3 indicating (2^{bf})³.

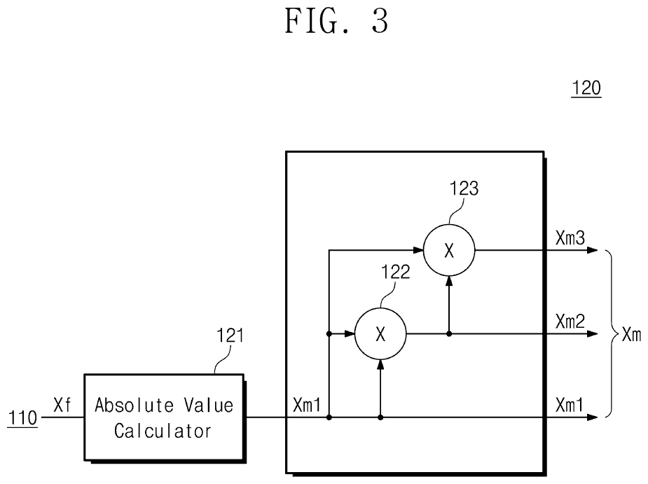

A more detailed description of the power calculator 120 will be described below with reference to FIG. 3.

The coefficient calculator 130 may generate the calculation data Xc. For example, the coefficient calculator 120 may generate the operation data Xc based on the multiplication data Xm received from the power calculator 120. In some embodiments, the operation data Xc may refer to values of a plurality of terms (except 1) in Equation 6. That is, the coefficient calculator 130 may perform multiplication operations of values indicated by the multiplication data Xm and corresponding coefficients, respectively, and generate operation data Xc indicating a result of the multiplication operations. The coefficient calculator 130 may provide the calculation data Xc to the adder-subtractor 140.

In some embodiments, the operation data Xc may include first to m-th order operation data Xc1:Xcm. For example, the operation data Xc may include first operation data Xc1 indicating a result of the multiplication operation of the first coefficient and 2^{bf}, second operation data Xc2 indicating a result of a multiplication operation of the second coefficient and (2^{bf})², and third operation data Xc3 indicating a result of multiplication operation of the third coefficient and (2^{bf})³. The first to third coefficients may respectively correspond to coefficients of a plurality of terms of Equation 6.

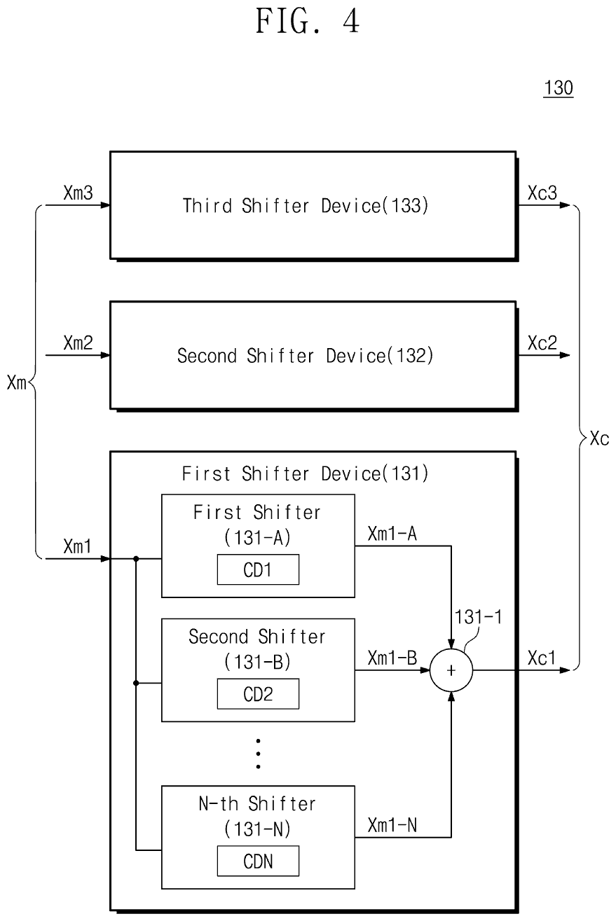

A more detailed description of the coefficient calculator 130 will be described below with reference to FIG. 4.

The adder-subtractor 140 may generate the addition data Xa. For example, the adder-subtractor 140 may generate the addition data Xa based on the operation data Xc received from the coefficient calculator 130 and the sign data Xs received from the divider 110. The addition data Xa may correspond to 2^{bf} in Equation 6) The adder-subtractor 140 may provide the addition data Xa to the shifter 150.

In some embodiments, the adder-subtractor 140 may perform an addition operation or a subtraction operation on the first to m-th operation data Xc1:Xcm included in the operation data Xc based on the sign data Xs. For example, in response to determining that the sign data Xs indicates the first level indicating a negative sign, the adder-subtractor 140 may generate the complements of some data included in the operation data Xc (e.g., the second operation data Xc2 indicating a term whose exponent is an odd number among the first to third operation data Xc1:Xc3), and perform an addition operation of the generated complement of the second operation data Xc2 and the remaining data (e.g, the first and third operation data Xc1 and Xc3). That is, the adder-subtractor 140 may perform a subtraction operation on some data by generating complements of some operation data indicating terms whose exponents are odd numbers based on the sign data Xs.

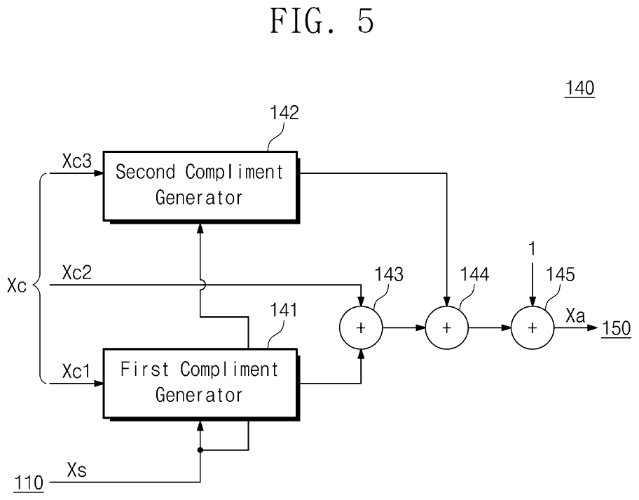

A more detailed description of the adder-subtractor 140 will be described below with reference to FIG. 5.

Shifter 150 may generate function data Xfs. For example, the shifter 150 may generate the function data Xfs based on the addition data Xa received from the adder-subtractor 140 and the integer data Xi received from the divider 110. The function data Xfs may correspond to a resulting value of an exponential function with the exponential data X as input.

In some embodiments, the shifter 150 may perform a shift operation on the addition data Xa corresponding to 2^{bf} in Equation 4 based on the integer data Xi corresponding to bi in Equation 4. The shifter 150 may perform a shift operation of shifting bits constituting the addition data Xa to the left by an integer indicated by the integer data Xi. For example, when the integer data Xi indicates 2, the shifter 150 may shift bits constituting the addition data Xa to the left twice. That is, the shifter 150 may perform a shift operation of the addition data Xa based on the integer data Xi, and generate the function data Xfs indicating a result of the shift operation.

FIG. 3 is a diagram illustrating a power calculator according to some embodiments of the present disclosure. Referring to FIG. 3, the power calculator 120 may include an absolute value calculator 121, a first multiplier 122, and a second multiplier 123. The power calculator 120 may generate the multiplication data Xm based on the decimal data Xf received from the divider 110. For example, the power calculator 120 may generate the multiplication data Xm including the first to third multiplication data Xm1:Xm3 based on the decimal data Xf. However, the first to third multiplication data Xm1:Xm3 are presented only to facilitate understanding of the power calculator 120 of the present disclosure, and are not intended to limit the scope of the present disclosure. The power calculator 120 may generate three or more multiplication data.

The absolute value calculator 121 may generate the first multiplication data Xm1. For example, the absolute value calculator 121 may perform an absolute value calculation on the decimal data Xf received from the divider 110 and generate the first multiplication data Xm1 indicating a result of the absolute value calculation of the decimal data Xf. The first multiplication data Xm1 may indicate b_{f} in Equation 6.

The first multiplier 122 may perform a first order power operation. For example, the first multiplier 122 may perform the first order power operation indicating the multiplication operation of the first multiplication data Xm1 and the first multiplication data Xm1, and generate the second multiplication data Xm2 indicating a result of the first order power operation. The second multiplication data Xm2 may refer to (b_{f})² in Equation 6.

The second multiplier 123 may perform a second order power operation. For example, the second multiplier 123 may perform a second order power operation indicating a multiplication operation of the first multiplication data Xm1 and the second multiplication data Xm2. The second multiplier 123 may generate third multiplication data Xm3 indicating a result of the second order power operation. The third multiplication data Xm3 may indicate (b_{f})³ in Equation 6.

The first and second multipliers 122, 123 are presented to aid understanding of the power calculator 120 of the present disclosure and are not intended to limit the scope of the present disclosure. The power calculator 120 may include two or more multipliers.

FIG. 4 is a diagram illustrating a coefficient calculator according to some embodiments of the present disclosure. Referring to FIG. 4, the coefficient calculator 130 may include first to third shifter devices 131:133. The coefficient calculator 130 may generate the calculation data Xc based on the multiplication data Xm received from the power calculator 120. For example, the coefficient calculator 130 may generate the operation data Xc including the first to third operation data Xc1:Xc3 based on the multiplication data Xm.

The first to third operation data Xc1:Xc3 and the first to third shifter devices 131:133 are presented only to assist in understanding the coefficient calculator 130 of the present disclosure, and are not intended to limit the scope of the present disclosure. The coefficient calculator 130 may generate three or more operation data, and may include three or more shifter devices.

The first shifter device 131 may generate the first operation data Xc1 based on the first multiplication data Xm1. For example, the first shifter device 131 may generate the first to N-th shifted data Xm1-A:Xm1-N corresponding to a result of right shift operations of the first multiplication data Xm1, and generate the first operation data Xc1 corresponding to the result of the addition operation of the first to N-th shifted data X m1-A:X m-N. N is any natural number.

The right shift operation may be an operation of shifting bits constituting data to the right. In some embodiments, the right shift operation may be an operation of adding bits that are zero to the position of the Most Significant Bit (MSB) of the data. For example, a right shift operation may refer to an operation of sequentially adding two bits that are zero to the position of the most significant bit of data. The operation of sequentially adding two (zero) bits to the position of the most significant bit of data may be similar to the operation of shifting the bits of data to the right twice.

In some embodiments, the first operation data Xc1, which is a sum of the first to N-th shifted data Xm1-A:Xm1-N, may correspond to an approximation value of one of the plurality of power terms in Equation 6 (e.g., the first order power term (0.69314) b_{f}). For example, when N is 4, 0.1011000101110001, which is a binary number of 0.69314, may be approximated as 0.10110001 (i.e., the binary number may be approximated to have N 1s).

In some embodiments, the first shifter device 131 may respectively shift the first multiplication data Xm1 based on positions of bits that are 1 included in 0.10110001. For example, the positions of the four 1 bits that 0.10110001 includes are 1, 3, 4, and 8, respectively. The first shifter device 131 may perform first to fourth right shift operations of shifting the first multiplication data Xm to the right once, three times, four times, and eight times, respectively, and generate first to fourth shifted data Xm1:Xm4 corresponding to a result of the first to fourth right shift operations, respectively. A sum of the first to fourth shifted data Xm1:Xm4 may be equal to a multiplication of 0.10110001 and the first multiplication data Xm1.

The first shifter device 131 may include first to N-th shifters 131-A:131-N and a first adder 131-1. The first to N-th shifters 131-A:131-N may include first to N-th coefficient data CD1:CDN, respectively. In some embodiments, the first to N-th coefficient data (CD1:CDN) may respectively refer to positions of N bits that are 1 constituting data of an approximated binary number (e.g., 0.10110001) of one of the coefficients of the plurality of terms of Equation 6 (e.g, 0.69314). For example, when N is 4, the first to fourth coefficient data CD1:CD4 may indicate positions 1, 3, 4, and 8, respectively, of bits that are 1 of 0.10110001, which is an approximated binary number of 0.69314.

The first shifter 131-A may perform a first right shift operation of the first multiplication data Xm1 based on the first coefficient data CD1. For example, when the first coefficient data CD1 indicates 1, the first shifter 131-A may shift bits of the first multiplication data Xm1 to the right once. In some embodiments, the first shifter 131-A may perform the first right shift operation by adding one zero bit to the most significant bit of the first multiplication data Xm1, based on the first coefficient data CD1. The first shifter 131-A may generate first shifted data Xm1-A corresponding to a result of the first right shift operation.

The second to N-th shifters 131-B:131-N are similar to the first shifter 131-A, and thus a detailed description thereof is omitted.

The first adder 131-1 may perform an addition operation on the first to N-th shifted data (Xm1-A:Xm1-N). The first adder 131-1 may generate the first operation data Xc1 corresponding to a result of the addition operation of the first to N-th shifted data (Xm1-A:Xm1-N).

The second and third shifter devices 132, 133 may generate the second and third operation data Xc2, Xc3 based on the second and third multiplication data Xm2, Xm3, respectively. The second and third operation data Xc2, Xc3 correspond the second-order and third-order power terms of Equation 6, (0.24022)(b_{f})² and (0.0555)(b_{f})³, respectively. The second and third shifter devices 132, 133 are similar to the first shifter device 131, so a detailed description thereof is omitted.

FIG. 5 is a diagram illustrating an adder-subtractor according to some embodiments of the present disclosure. Referring to FIG. 5, the adder-subtractor 140 may include first and second complement generators 141, 142, and first to third adders 143:145. The adder-subtractor 140 may generate the addition data Xa based on the operation data Xc received from the coefficient calculator 130 and the sign data Xs received from the divider 110. The adder-subtractor 140 may provide the addition data Xa to the shifter 150.

The first and second compliment generators 141, 142, and the first to third adders 143:145 are presented to aid understanding of the adder-subtractor 140 of the present disclosure, and are not intended to limit the scope of the present disclosure. The adder-subtractor 140 may include two or more complement generators and three or more adders.

The first complement generator 141 can generate a complement of the first operation data Xc1 based on the sign data Xs. For example, the first complement generator 141 may generate the complement of the first operation data Xc1 in response to determining that the sign data Xs indicates the first level (indicating a negative sign). The complement of the first operation data Xc1 may correspond to the negative of the value indicated by the first operation data Xc1. Further, the first complement generator 141 may bypass the first operation data Xc1 in response to determining that the sign data Xs indicates the second level indicating the positive sign.

The first complement generator 141 can provide the complement of the first operation data Xc1 or the bypassed first operation data Xc1 to the first adder 143. For example, when the sign data Xs indicates a first level indicating a negative sign, the first complement generator 141 may provide the complement of the first operation data Xc1 to the first adder 143. Also, when the sign data Xs indicates the second level indicating the positive code, the first complement generator 141 may provide the bypassed first operation data Xc1 to the first adder 143.

The second complement generator 142 may generate a complement of the third operation data Xc3 based on the sign data Xs. In addition, the second complement generator 142 may provide the complement of the third operation data Xc3 or the bypassed third operation data Xc3 to the second adder 144. The second complement generator 142 is similar to the first complement generator 141, so a detailed description thereof is omitted.

The first adder 143 may perform an addition operation on the first operation data Xc1 (or the complement of the first operation dataXc1) and the second operation data Xc2. For example, when the sign data Xs indicates the first level (indicating a negative sign), the first adder 143 may receive the complement of the first operation data Xc1 from the first complement generator 141, and perform an addition operation of the complement of the first operation data Xc1 and the second operation data Xc2. That is, the first adder 143 may perform a subtraction operation on the first and second operation data Xc1 and Xc2.

In addition, when the sign data Xs indicates the second level (indicating a positive sign), the first adder 143 may receive the bypassed first operation data Xc1 from the first complement generator 141, and perform an addition operation of the first operation data Xc1 and the second operation data Xc2. That is, the first adder 143 may perform an addition operation on the first and second operation data Xc1 and Xc2.

The second adder 144 may perform an addition operation of a result of the addition operation of the first adder 143 and the third operation data Xc3 (or the complement of the third operation data Xc3) received from the second complement generator 142.

The third adder 145 may perform an addition operation of 1 and an addition operation result of the second adder 144. 1 may correspond to 1 of the first term in Equation 6. The third adder 145 may generate the addition data Xa corresponding to the result of the addition operation. The addition data Xa may correspond to a sum of a plurality of terms in Equation 6 or an approximate value of 2^{bf}.

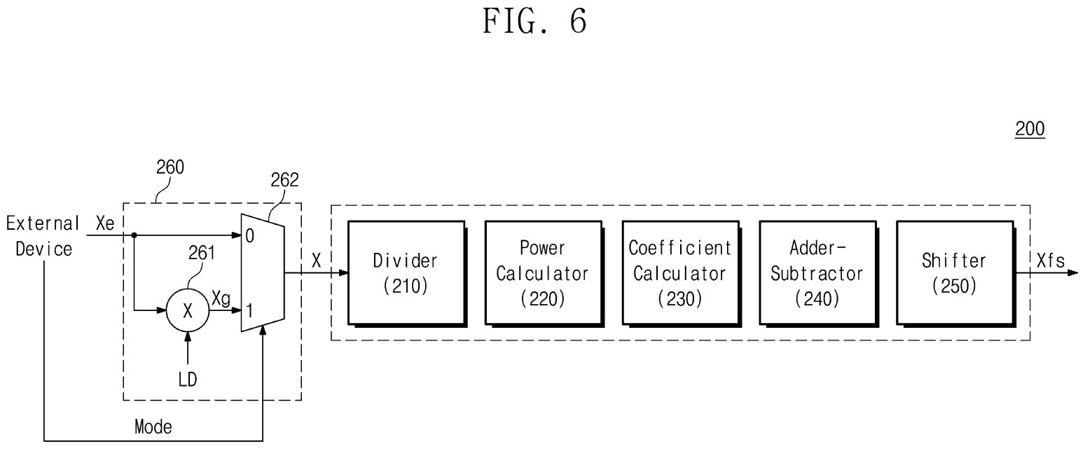

FIG. 6 is a block diagram illustrating an exponential function calculator in accordance with some embodiments of the present disclosure. Referring to FIG. 6, the exponential function calculator 200 may include a divider 210, a power calculator 220, a coefficient calculator 230, an adder-subtractor 240, a shifter 250, and a scaler 260. The exponential function calculator 200 may calculate an exponential function having a real number other than 2 as a base. For example, the exponential function calculator 200 may operate an exponential function with raw data Xe as an input and with e as a base, which is a natural constant (or a base of a natural logarithm).

Exponential functions having a natural constant (or a base of a natural logarithm) e as a base are presented to aid in understanding the exponential function calculator 200 of the present disclosure, and are not intended to limit the scope of the present disclosure. The exponential function calculator 200 may calculate an exponential function having any real number as a base.

The divider 210, the power calculator 220, the coefficient calculator 230, the adder-subtractor 240, and the shifter 250 are similar to the divider 110, the power calculator 120, the coefficient calculator 130, the adder-summer 140, and the shifter 150 of FIG. 2, and thus a detailed description thereof is omitted.

The scaler 260 may generate exponential data X based on the raw data Xe. For example, the scaler 260 may generate the exponential data X based on the raw data Xe and the mode signal Mode to scale an exponential function having a real number other than 2 as a base to an exponential function having 2 as a base. The scaler 260 may provide the exponential data X to the divider 210.

In some embodiments, the scaler 260 may receive the raw data Xe and the mode signal (Mode) from an external device (e.g., the processor 11, the main memory 12, or the storage device 13 of FIG. 1), and determine, based on the mode signal (Mode), the scaling data Xg that is a result of the multiplication operation of the raw data Xe or the raw data Xe as the exponential data X.

The scaler 260 may include a multiplier 261 and a multiplexer 262. The multiplier 261 may perform a multiplication operation of the raw data Xe and the log data LD (e.g., log₂e). The multiplier 261 may generate the scaling data Xg corresponding to a multiplication operation result of the raw data Xe and the log data LD. For example, when the base of the exponential function is e, the multiplier 261 may perform a multiplication operation of the raw data and the log data LD indicating log₂e, and generate the scaling data Xg.

The multiplexer 262 may determine one of the raw data Xe and the scaling data Xg as the exponential data X based on the mode signal (Mode). For example, when the mode signal (Mode) is at a first level (indicating that the base of the exponential function is 2), the multiplexer 262 may determine the raw data Xe as the exponential data X. Also, when the mode signal (Mode) is at the second level (indicating that the base of the exponential function is not 2), the multiplexer 262 may determine the scaling data Xe as the exponential data X.

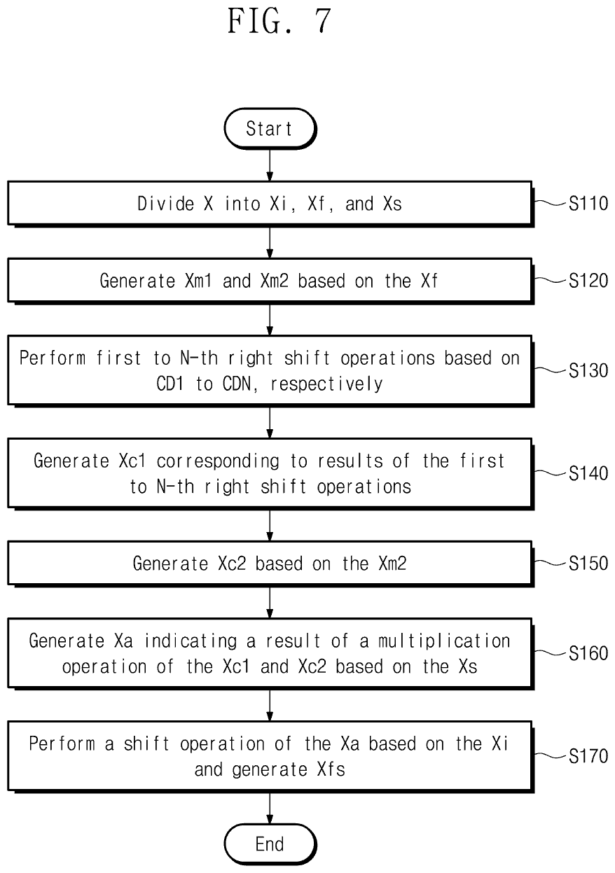

FIG. 7 is a flowchart illustrating a method of operating an exponential function calculator according to an embodiment of the present disclosure. Referring to FIG. 7, the exponential function calculator 100 of FIG. 2 may operate an exponential function with exponential data X as an input, and generate function data Xfs corresponding to a result of the exponential function.

In step S110, the exponential function calculator may divide the exponential data X into integer data Xi, decimal data Xf, and sign data Xs. For example, the exponential function calculator can divide exponential data X that is an arbitrary real number into the integer data Xi that is an integer part of the exponential data X, the decimal data Xf that is a decimal part, and the sign data Xs indicating a sign of the exponential data X.

At step S120, the exponential calculator may generate first and second multiplication data Xm1, Xm2 based on the decimal data Xf. For example, the exponential function calculator may generate the first multiplication data Xm1 that is equal to the decimal data Xf, and generate the second multiplication data Xm2 that indicates a result of a first-order power operation of the decimal data Xf. The first-order power operation may refer to a multiplication operation of the decimal data Xf and the first multiplication data Xm1.

In step S130, the exponential function calculator may perform first to N-th right shift operations of the first multiplication data Xm1 based on the first to N-th coefficient data CD1:CDN, respectively. N is a natural number.

In step S140, the exponential function calculator may generate first operation data Xc1 corresponding to a sum of results of the first to N-th right shift operations.

In operation S150, the exponential function calculator may generate second operation data Xc2 based on the second multiplication data Xm2. For example, the exponential function calculator may perform (N+1)-th to 2N-th right shift operations of the second multiplication data based on (N+1)-th to 2N-th coefficient data, respectively, and generate second operation data Xc2 corresponding to a sum of results of the (N+1)-th to 2N-th right shift operations.

In operation S160, the exponential function calculator may generate addition data Xa indicating a result of the addition operation of the first operation data Xc1 and the second operation data Xc2 based on the sign data Xs. For example, the exponential function calculator may generate a complement of the first operation data Xc1 based on the sign data Xs, perform an addition operation of the complement of the first operational data Xc1 and the second operational data Xc2, and generate the addition data Xa indicating a result of the addition operation.

In step S170, the exponential function calculator may perform a shift operation of the addition data Xa based on the integer data Xi, and generate function data Xfs indicating a result of the shift operation. For example, the exponential function calculator may perform a shift operation of shifting bits constituting the addition data Xa to the left by an integer indicated by the integer data Xi. When the integer data Xi is 2, the shifter may shift bits constituting the addition data Xa to the left twice. The function data Xfs may correspond to an operation result of an exponential function having the exponential data X as an input.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An exponential function calculator comprising:
a divider configured to divide exponential data into integer data, decimal data, and sign data;
a power calculator configured to generate first multiplication data equal to the decimal data, and to generate second multiplication data indicating a result of a first order power operation of the decimal data;
a coefficient calculator configured to generate first operation data based on the first multiplication data, and generate second operation data based on the second multiplication data;
an adder-subtractor configured to generate addition data indicating a result of an addition operation of the first operation data and the second operation data based on the sign data; and
a shifter configured to perform a shift operation of the addition data based on the integer data and to generate function data indicating a result of the shift operation,
wherein the coefficient calculator is further configured to perform first to N-th right shift operations of the first multiplication data based on first to N-th coefficient data, respectively, and to generate the first operation data corresponding to a sum of results of the first to N-th right shift operations, and
wherein N is a natural number.

2. The exponential function calculator of claim 1, wherein the power calculator includes a first power calculator configured to perform the first order power operation which is a multiplication operation of the decimal data and the first multiplication data.

3. The exponential function calculator of claim 2, wherein the power calculator further includes a second power calculator configured to perform a second order power operation on the decimal data, and to generate third multiplication data indicating a result of the second order power operation that is a multiplication operation of the decimal data and the second multiplication data.

4. The exponential function calculator of claim 1, wherein the coefficient calculator includes a first shifter device, and
wherein the first shifter device includes first to N-th shifters configured to generate first to N-th shifted data corresponding to a result of the first to N-th right shift operations, and a first adder configured to perform an addition operation of the first to the N-th shifted data.

5. The exponential function calculator of claim 4, wherein the first to N-th shifters add one or more bits having a first value to a position of a most significant bit (MSB) of the multiplication data based on the first to N-th coefficient data to generate the first to N-th shifted data, respectively.

6. The exponential function calculator of claim 1, wherein the first to N-th coefficient data respectively indicates positions of bits having a second value of a plurality of bits comprising data of a first coefficient related to a Maclaurin series of an exponential function, and
wherein the first coefficient comprises values in which a coefficient of a first order power term of the Maclaurin series is approximated such that the number of the bits having the second value is N.

7. The exponential function calculator of claim 1, wherein the coefficient calculator is further configured to perform (N+1)-th to 2N-th right shift operations of the second multiplication data based on (N+1)-th to 2N-th coefficient data, respectively, and to generate the second operation data corresponding to a sum of results of the (N+1)-th to 2N-th right shift operations.

8. The exponential function calculator of claim 1, wherein the adder-subtractor includes a complement generator configured to generate a complement of the first operation data, a first adder configured to generate sub-addition data, and a second adder configured to perform an addition operation of the addition data and data having a first value,
wherein the complement generator is configured to generate a complement of the first operation data in response to determining that the sign data indicates a first level, and
wherein the first adder is configured to perform the addition operation of the complement of the first operation data and the second operation data when the sign data indicates the first level, and to perform the addition operation of the first operation data and the second operation data when the sign data indicates a second level.

9. The exponential function calculator of claim 1, further comprising a scaler configured to receive raw data and a mode signal from an external device, and to provide the exponential data to the divider; and
wherein the scaler includes:
a multiplier configured to perform a multiplication operation of the raw data and log data to scale the raw data and to generate scaling data corresponding to a result of the multiplication operation; and
a multiplexer configured to determine one of the raw data and the scaling data as the exponential data based on the mode signal.

10. A method for operating an exponential function calculator comprising:
dividing the exponential data into integer data, decimal data, and sign data;
generating first multiplication data that is equal to the decimal data;
generating second multiplication data indicating a result of a first power operation of the decimal data;
performing first to N-th right shift operations of the first multiplication data based on first to N-th coefficient data, respectively, wherein N is a natural number;
generating the first operation data corresponding to a sum of results of the first to N-th right shift operations;
generating second operation data based on the second multiplication data;
generating addition data indicating a result of an addition operation of the first operation data and the second operation data based on the sign data; and
performing a shift operation of the addition data based on the integer data, and generating function data indicating a result of the shift operation.

11. The method of claim 10, wherein performing the first to N-th right shift operations of the first multiplication data, respectively, includes:
adding one or more bits having a first value to a position of a most significant bit (MSB) of the multiplication data based on the first to N-th coefficient data to generate the first to N-th shifted data, respectively.

12. The method of claim 10, wherein the first to N-th coefficient data respectively indicate positions of bits having a second value of a plurality of bits comprising data of a first coefficient related to a Maclaurin series of an exponential function, and
wherein the first coefficient comprises values in which a coefficient of a first order power term of the Maclaurin series is approximated such that the number of the bits having the second value is N.

13. The method of claim 10, wherein generating the second operation data includes:
performing (N+1)-th to 2N-th right shift operations of the second multiplication data based on (N+1)-th to 2N-th coefficient data, respectively, and
generating the second operation data corresponding to a sum of results of the (N+1)-th to 2N-th right shift operations.

14. The method of claim 10, wherein dividing the exponential data into the integer data, the decimal data, and the sign data includes:
receiving raw data and a mode signal from an external device;
performing a multiplication operation on the raw data and log data to scale the raw data;
generating scaling data corresponding to a result of the multiplication operation; and
determining one of the raw data and the scaling data as the exponential data based on the mode signal.
